(19) United States
(12) Patent Application Publication
(10) Pub. No.: US 2026/0113258 A1
(43) Pub. Date: Apr. 23, 2026

(54) SYSTEMS AND METHODS OF ERROR DATA COLLECTION AND ANALYSIS

(71) Applicant: Dell Products L.P., Round Rock, TX (US)

(72) Inventors: Thyagarajan Ramakrishnan, Bangalore (IN); Ramya Ramakrishnan, Bangalore (IN); Sunil Gumaste, Bengaluru (IN)

(73) Assignee: Dell Products L.P., Round Rock, TX (US)

(21) Appl. No.: 18/919,567

(22) Filed: Oct. 18, 2024

(51) Int. Cl. H04L 43/0823; H04Q 9/02

(52) U.S. Cl. CPC H04L 43/0847; H04Q 9/02

(57) ABSTRACT

Methods and systems providing a holistic approach to error data collection in a complex system, such as a distributed storage system, are disclosed. Telemetry data across a number of system components and their operational attributes is collected, structured and used to generate a correlation matrix. The correlation matrix is used to generate a graph. The graph includes a plurality of nodes corresponding to the plurality of attributes and a plurality of edges corresponding to a correlation between at least two nodes. The graph indicates correlated attributes such that, upon detection of an error, attribute data relating to correlated nodes is packaged and transmitted for error analysis.

### BACKGROUND

In a complex system, like a distributed storage system, multiple components work together to accomplish a number of tasks or functions. Each of these components have their own attributes and properties related to the operation of the individual component as well as the system as a whole. Many of these attributes are related to other attributes, both within the same component and other system components. Due to the complexity of the system, when a failure or error occurs, it is difficult to collect relevant, complete and accurate operational data in a timely and efficient manner. System dumps and pre-defined data collection policies do not effectively and efficiently capture the most important (e.g., high-value) data at the time of the error.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

According to one aspect, a method of collecting high-value error data may include providing an error map associating one or more system attributes to an error code, detecting a system error, and identifying, in the error map, one or more first system attributes associated with the error code. One or more second system attributes associated with the one or more first system attributes may be identified. The one or more second system attributes may be correlated with the one or more first system attributes according to a correlation graph. Telemetry data related to the one or more first and second system attributes may be collected, a data package may be generated including the error code and the telemetry data related to the one or more first and second system attributes.

The method may further include, alone or in combination, one or more of the following features. A correlation matrix of the one or more system attributes may be generated. The correlation graph may be generated from the correlation matrix. The correlation graph may include a plurality of nodes corresponding to the one or more first and second system attributes and a plurality of edges corresponding to a correlation between at least two nodes of the plurality of nodes. A length of an edge in the correlation graph may be indicative of a correlation strength between two error attributes represented by the two nodes. The correlation strength may increase as the length of the edge decreases. The telemetry data may include a point-in-time snapshot of a plurality of values associated with the one or more first and second system attributes. The correlation graph may be generated from telemetry data. The correlation graph may be periodically generated using updated telemetry data.

According to another aspect, a system may include a memory; and at least one processor that is operatively coupled to the memory. The at least one processor may be configured to perform the operations of providing an error map associating one or more system attributes to an error code, detecting a system error, and identifying, in the error map, one or more first system attributes associated with the error code. One or more second system attributes associated with the one or more first system attributes may be identified. The one or more second system attributes may be correlated with the one or more first system attributes according to a correlation graph. Telemetry data related to the one or more first and second system attributes may be collected, a data package may be generated including the error code and the telemetry data related to the one or more first and second system attributes.

The system may further include, alone or in combination, one or more of the following features. A correlation matrix of the one or more system attributes may be generated. The correlation graph may be generated from the correlation matrix. The correlation graph may include a plurality of nodes corresponding to the one or more first and second system attributes and a plurality of edges corresponding to a correlation between at least two nodes of the plurality of nodes. A length of an edge in the correlation graph may be indicative of a correlation strength between two error attributes represented by the two nodes. The correlation strength may increase as the length of the edge decreases. The telemetry data may include a point-in-time snapshot of a plurality of values associated with the one or more first and second system attributes. The correlation graph may be generated from telemetry data. The correlation graph may be periodically generated using updated telemetry data.

According to another aspect, a non-transitory computer-readable medium may store one or more processor-executable instructions, which when executed by at least one processor cause the at least one processor to perform the operations of providing an error map associating one or more system attributes to an error code, detecting a system error, and identifying, in the error map, one or more first system attributes associated with the error code. One or more second system attributes associated with the one or more first system attributes may be identified. The one or more second system attributes may be correlated with the one or more first system attributes according to a correlation graph. Telemetry data related to the one or more first and second system attributes may be collected, a data package may be generated including the error code and the telemetry data related to the one or more first and second system attributes.

The non-transitory computer-readable medium may further include, alone or in combination, instructions for performing one or more of the following features. A correlation matrix of the one or more system attributes may be generated. The correlation graph may be generated from the correlation matrix. The correlation graph may include a plurality of nodes corresponding to the one or more first and second system attributes and a plurality of edges corresponding to a correlation between at least two nodes of the plurality of nodes. A length of an edge in the correlation graph may be indicative of a correlation strength between two error attributes represented by the two nodes. The correlation strength may increase as the length of the edge decreases.

### BRIEF DESCRIPTION OF THE DRAWINGS

Other aspects, features, and advantages of the claimed invention will become more fully apparent from the following detailed description, the appended claims, and the accompanying drawings in which like reference numerals identify similar or identical elements. Reference numerals that are introduced in the specification in association with a drawing figure may be repeated in one or more subsequent figures without additional description in the specification in order to provide context for other features.

FIG. 1 is a block diagram of a complex system, according to aspects of the present disclosure;

FIG. 2A is a flow diagram of workflow for an efficient collection operation for high-value data, according to aspects of the present disclosure;

FIG. 2B is an example of an error attribute map, according to aspects of the present disclosure;

FIG. 3A is an example of a data structure, according to aspects of the present disclosure;

FIG. 3B is an example of a correlation matrix, according to aspects of the present disclosure;

FIG. 4 is an example of a graph of a correlation network, according to aspects of the present disclosure;

FIG. 5 is a method of collecting high-value error data, according to aspects of the present disclosure;

FIG. 6 is a diagram of an example of a storage system, according to one or more aspects of the present disclosure; and

FIG. 7 is a diagram of an example of a computing device, according to one or more aspects of the present disclosure.

### DETAILED DESCRIPTION

Aspects of the present disclosure include methods and systems for providing a holistic approach to collecting high-value error data in a complex system, such as a distributed storage system. Telemetry data across a number of system components and their operational attributes may be collected, structured and used to generate a correlation matrix. The collected attribute data may include data from within a given component and/or data obtained from other system components working in conjunction with the given component. The attribute data may be, in one aspect, associated with or relevant to the occurrence of one or more system errors. The correlation matrix may be used to generate a graph showing the interrelations of certain attributes and their connections to system errors. The graph may include a plurality of nodes corresponding to the plurality of attributes and a plurality of edges corresponding to a correlation between at least two nodes of the plurality of nodes. From the graph, relationships between the components and their attributes may be defined and examined in the context of a system error. The graph may provide insights as to the correlation between the attributes of the system and high-value data beneficial in analyzing, troubleshooting and fixing system errors.

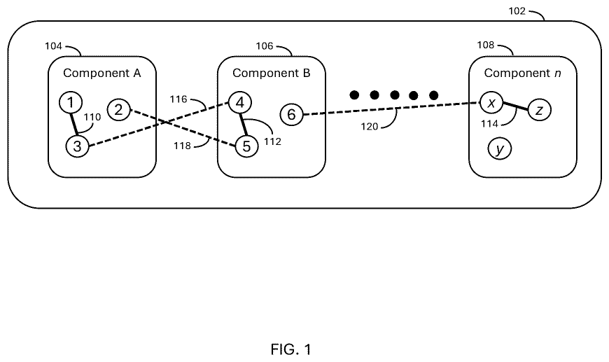

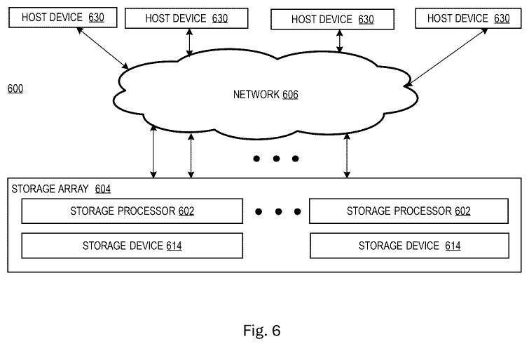

FIG. 1 is a block diagram of a complex system 102, according to aspects of the present disclosure. The system 102 may include or be defined by a number of components working in conjunction to accomplish one or more objectives. For example, and described herein, a complex system may be a distributed storage system, like that shown in FIG. 6. As shown in FIG. 1, the system 102 may include a number of components, such as Component A 104 and Component B 106 through Component n 108. Information regarding the operation of each component may be derived from multiple attributes. Each component may include or define one or more attributes related to the operation and function of the component.

According to one aspect, the attributes of a component may be related to other attributes of the component and/or other components. As used herein, an intra-component relation may be used to describe a relation between one or more attributes of the same component. An inter-component relation, as used herein, may indicate a relation between an attribute of a first component and one or more attributes of a second component. In the exemplary system 102 of FIG. 1, Component A may include attributes 1, 2, and 3. In operation, a change in attribute 1 may result in a corresponding change in attributes, as indicated by the solid line 110. Similarly, a change in attribute 3 of Component A 104 may result in a corresponding change in attribute 4 of Component B 106, shown by the dotted line 116. As shown in FIG. 1, solid lines 110, 112, 114 may indicate inter-component relations, while the dotted lines 116, 118, 120 may indicate intra-component relations.

When the system experiences an error, determining the reason for the error can be difficult given the complexity of the system. For example, if an error occurs somewhere in the system, by the time a support team is notified of the error, the system state may have changed and relevant and contemporaneous information may have been lost as the system state may change continuously over time. If the error and its solution require escalation of the issue to a development or sustaining team the time to an implemented solution is even longer. While wholesale dumps of system data may capture all data at the time of an error, such data can be voluminous and cumbersome. Further, system errors can often occur as a result of some event occurring on a related component. If the relationship between the components, and their operational attributes is unknown, it may be difficult to identify the source of the problem and also provide a comprehensive fix.

Traditional methods of identifying the source of a problem in a complex system may rely heavily on root cause analysis (RCA) and subject matter expertise (SME). In the context of the system 102, if a failure occurs on Component A 104, RCA and SME methodologies may consider the data captured for local attributes 1, 2. These methodologies may also consider the relation between attribute 1 and attribute 2 to determine if there is a causal or a correlated effect. While an engineer or technician may have some level of expertise, that expertise may be limited in knowledge and/or availability. For example, there may be a correlated effect been attribute 3 of Component A 103 and attribute 4 of Component B 106. Traditional RCA and SME methodologies may not examine the inter-component relation between attributes of different components because the subject matter expert may not know of the correlation between seemingly unrelated attributes of separate components.

Further, in the context of error detection, when a system experiences an error that requires escalation of the problem to a support of development team, The traditional timeline of reporting the error to a support team followed by the support team attempting to retrieve relevant error data from the system is an inefficient and ineffective process. In particular, the system state may have changed in the time between the error is detected and reported and the time when a support service or technician can pull system data. In such a case, stale system data can hinder or prevent a complete and holistic view of the system at the time the error occurred. In some cases, full system data dumps may be triggered by an error, however such dumps can be too large and cumbersome from which to effectively pull high-value data.

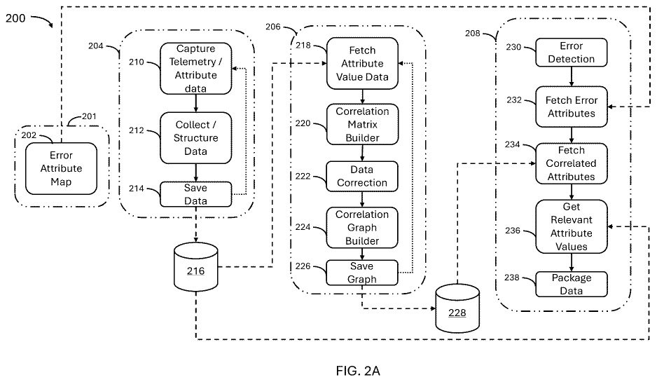

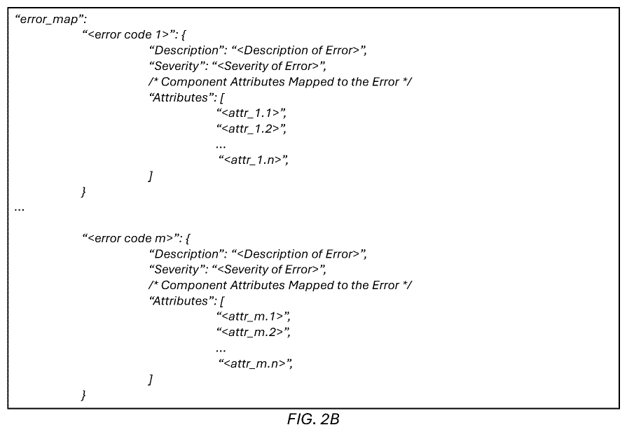

FIG. 2A is a flow diagram of workflow 200 for a high-value error data collection system, according to aspects of the present disclosure. The workflow 200 may include or be defined according to three phases. A first phase 201 (e.g. a prerequisite) may include defining and generating an error map. A second phase (e.g., pre-error), shown as block 204 and block 206, may include the collection of operational system information (block 204) and the generation of correlation information (block 206). A third phase 208 (e.g. post-error) may include a practical application in which an error is detected and high-value data may be collected and packaged for analysis and solution development.

According to one aspect, the first phase 201 may include defining an error attribute map 202. The error attribute map 202 may be or include a listing of potential errors and error codes that may be known to occur in a complex system. According to one aspect, the error attribute map may be static and predefined according to known related attributes. The error attribute map 202 may identify the error or error code and include an association to one or more system attributes that may be known to contribute to or be affected by the error. FIG. 2B represents an example structure of the error attribute map, according to one aspect of the disclosure. For each error code “<error code 1>”, a description, a severity, and a number of component attributes (e.g., “<attr_1.1>”, “<attr_1.2>” “<attr_1.n>”, may be defined. According to one aspect the component attributes may represent various data metrics measured, detected or otherwise captured during system operation.

Accordingly, it may be known by a system designer, subject matter expert (SME) or the like, that when “<error code 1>” occurs in a system, the error may be affected by, or have an effect on, other system attributes, for example “<attr_1.1>”, “<attr_1.2>”... “<attr_1.n>”.

These system attributes may be identified according to knowledge and experience of a designer with the particular complex system. In known error data collection systems, however, the analysis of a detected error (e.g., “<error code 1>”), only data related to the known related system attributes (e.g., “<attr_1.1>”, “<attr_1.2>” “<attr_1.n>”) may be considered in troubleshooting or correcting the error. Aspects of the present disclosure provide for expanding the identification of impacted or impacting system attributes in order to collect and provide a more comprehensive and efficient data set for analysis.

Returning to FIG. 2A, a second phase of the workflow 200 may include, as shown in block 204, capturing telemetry data (e.g., data automatically measured, recorded and transmitted to a location for monitoring and analysis). In a complex storage system, telemetry data may include, for example and without limitation, error counters, input/output (I/O) per second (IOPS), response rates, request rates, request latency rates, outgoing byte rates, average I/O wait time, I/O load, reads, writes, counters, data movements, defragmentation data, page cache reads ratios, disk usage, central processing unit (CPU) usage, memory utilization, network bytes sent, network bytes received, and the like.

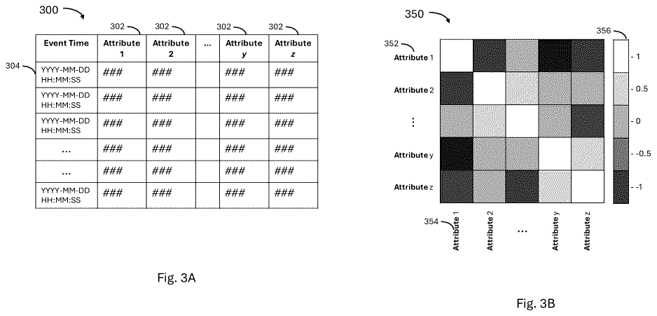

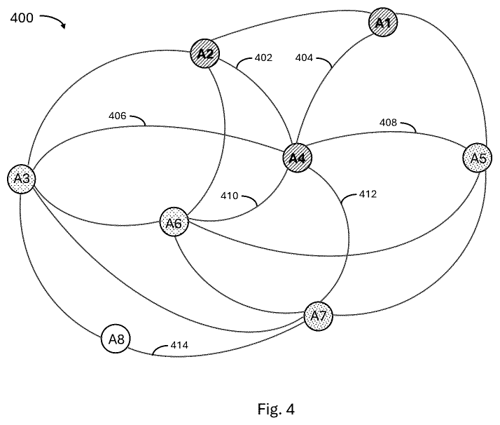

As shown in block 212, the telemetry data may be collected, structured and saved in a location where it may be analyzed and monitored. The data may be collected from the system components in real-time as system events occur, on a periodic basis according to a predetermined period, and/or in response to an error, any of which may trigger a collection of attribute data and subsequent transmission from the components. Once collected, the data may be formatted and saved, shown in block 214, in a datastore 216 or other memory, into a data structure suitable for and inputting to a matrix builder. The data structure may be a time-ordered table (e.g., 300, FIG. 3A) or the like for storing a number of recent sample data for all system attributes. According to one aspect, the operations of block 204 may be executed periodically to build and maintain a robust and up-to-date attribute value datastore that accurately reflects the state of the system.

According to one aspect, another portion of the second phase, denoted as block 206, may include retrieving attribute data and using such data to generate a correlation graph. Shown in block 218, attribute data may be retrieved (e.g. fetched) from the datastore 216 and input into a correlation matrix builder 220. The matrix builder 220 may receive the saved and structured data to build a correlation matrix that captures and quantifies a potential correlation between any two or more of the input attributes. As shown in block 222, the correlation matrix data may be analyzed and corrected to account for any spurious or outlier data.

With the correlation matrix corrected, a graph builder 224 may use the correlation matrix to build a correlation network graph. As described herein, the graph may include nodes representing the various attributes of the system components. Edges connecting two nodes in the graph may represent a correlation between the nodes. According to one aspect, as described herein, graph edges may be generated linking attributes that are related across the various system components. Accordingly, the correlation graph may provide a practical insight as to potential cause and effect or correlated dependencies on a system-wide level. The graph may be stored, shown in block 226, in a database 228, or other memory. According to one aspect, the correlation graph may be periodically generated and/or updated to ensure the most recent attributes and their correlations are accurately captured.

According to one aspect, a third phase 208 of the workflow 200 may include the practical application of detecting an error and generating a contemporaneous, comprehensive and high-value response to the error for advanced analysis and troubleshooting. According to one aspect, shown in block 230, a system error may be detected according to a policy, triggering event, or the like. The system may utilize the correlation graph to identify related attributes that affect or are affected by the error, collect data related to those attributes and generate a data package containing all relevant and high-value information to be transmitted to a support system or team.

According to one aspect, upon detection of an error, the system may read the error attribute map 202 and determine, based on the error code associated with the detected error, a first set of attributes related to the error, shown in block 232. As described herein, the attributes listed under the error code in the error attribute map 202 may be predefined attributes known by an SME, system designer, or the like. As described herein, the predefined attributes, however, may not provide a complete record of what was happening in and throughout the system when the error occurred. Accordingly, as shown in block 234, the system may fetch, read, or otherwise access the correlation graph from the database 228 to determine a second set of attributes (e.g., correlated error attributes) correlated to the first set of attributes defined in the error attribute map 202 for the detected error. The nodes and edges of the correlation graph may identify the second set of attributes related to the first set and a level of correlation among the identified attributes.

According to one aspect, armed with the identification of the first and second set of attributes, the system may fetch the most recent values for those attributes from the datastore 216. The values in the datastore, according to one aspect, are periodically updated and, as such, provide a contemporaneous snapshot of the relevant system components, attributes and their values at the time of the error. The system may generate a data package including the error code, the first and second sets of attributes and their values. The data package may be sent to a support team or a development team for analysis, troubleshooting. The data package provides a holistic view of the high-value data related to the error at the time the error occurred. Rather than uploading entire system dumps or fetching stale and out-of-date system information, the aspects of the present disclosure provide a comprehensive and effective tool for identifying relevant and contemporaneous data that may be used to find a solution to a system error.

FIG. 3A is an example of a data structure 300, according to aspects of the present disclosure. The data structure 300 may include a table-like format whereby attribute data 302 related to events may be ordered according to an event time 304 or other timestamp. Accordingly, at each event time 304 the structure may include values for each attribute (Attribute 1-Attribute z) captured. The data structure 300 may be input to a matrix builder to generate a correlation matrix reflecting a level of correlation between the attributes over time.

FIG. 3B is an example of a correlation matrix 350, according to aspects of the present disclosure. The correlation matrix 350 may reflect potential relations between attributes and, in one aspect, error attributes, shown as attribute rows 352 and attribute columns 354. A correlation scale 356 may indicate a level of correlation between the attributes. A 1:1 correlation, for example an attributes correlation with itself, may be given a value of ‘1’. According to one aspect, a positive correlation may be given if two attributes change in the same manner (e.g., positive or negative), such as while a negative correlation may be given if the two attributes change in an opposing manner (e.g. one attribute increases, while the other decreases). If one attribute changes and a second attribute has not change, a zero correlation may be given. While the correlation matrix 350 shown in FIG. 3B includes 5 correlation levels or ratings, one skilled in the art will recognize that the correlation scale 356 may include correlation levels of any granularity or scale.

FIG. 4 is an example of a graph 400 of a correlation network (e.g., a correlation graph), according to aspects of the present disclosure. The graph 400 may represent a spider-web-like structure which may indicate changes in any component or attribute cascading through to affect the related components or attributes. The exemplary graph 400 includes eight attributes (A1-A8) linked by one or more edges denoting a correlated relation based on a correlation matrix generated by the concepts and techniques described herein. According to one aspect, certain relations between two attributes may be known. For example, it may be known or well recognized that a change in attribute A4 may have a direct effect on attribute A2, reflected by edge 402, and a direct effect on attribute A1, reflected by edge 404. According to one aspect, attributes A1, A2 and A4 may represent attributes defined in a static error attribute map, as described herein.

It may not be readily apparent, however, that an attribute, like attribute A3, has a direct correlation with attribute A4 (edge 406), or that attributes A5, A6 and A7 also have a direct correlation with attribute A4 (edges 408, 410 and 412, respectively). The graph 400, however, may reflect, based on the generated correlation matrix, that indeed those attributes are correlated and a change in one of those attributes may result in a change in the other attribute. Similarly, graph 400 also indicates potential indirect relations between attributes. For example, attribute A8, while not directly linked to attribute A4, is linked indirectly through edges 412 and 414. As such, a change in attribute A4 may have an indirect impact on attribute A8, or vice versa (i.e., a change in attribute A8 may have an indirect impact on attribute A4).

According to one aspect, the graph 400 may provide the necessary insight that events occurring in these attributes have effects on attributes and components not previously known. In the exemplary context of an error detection, if a detected error and its error code indicate in the error attribute map that attributes A1, A2 and A4 (a first set of attributes) are high-value data attributes related to the error, the graph 400 may provide additional insight that attributes A3, A5, A6, and A7 (a second set of attributes) also may provide high-value data related to the error. The relationship between attribute A4 and Attributes A3, A5, A6, and A7 may previously be unknown to the system, a support technician, or the system designer. However, the correlation graph may indicate there is indeed a relationship. The additional knowledge of those relationships provides practical advantages over working only with known, and static attribute relationships.

According to one aspect, the graph 400 may include additional information including an indication of the strength or weakness of a correlation between two attributes. For example, the length of the edges in the correlation graph may be indicative of the correlation strength. In the example graph 400, A4's correlation to attributes A1, A2 and A6 may be stronger than A4's correlation to attributes A3, A7 and A5 as the edges 402, 404 and 410 are shorter than edges 406, 408 and 412. According to one aspect, a longer edge length may indicate a weaker correlation. The correlation strength is another factor that may help in diagnosing the error and its causes.

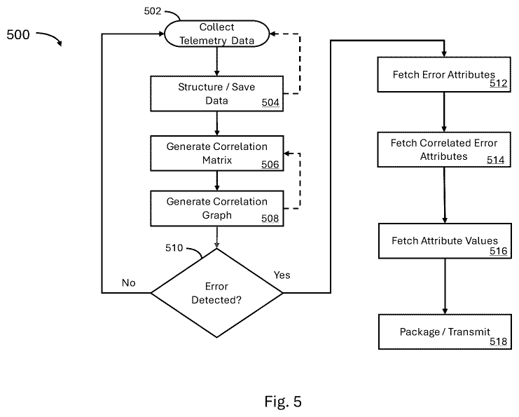

FIG. 5 is a method 500 of collecting high-value error data, according to aspects of the present disclosure. As described herein, and shown in block 502, the system may collect operational telemetry data from the components of the system. As shown in block 504, the collected telemetry data may be structured and saved in a datastore. The telemetry data may be collected, structured and saved periodically to ensure the data is up to date with the current system state.

As shown in block 506, a correlation matrix may be generated from the telemetry data, and in particular, according to one aspect, telemetry data relating to error attributes (e.g., system metrics that indicate or are related to error generation). The correlation matrix may be used to generate a correlation graph reflecting the direct and indirect relationships between the attributes, shown in block 508. According to one aspect, the system may periodically update and regenerate the correlation matrix and the correlation graph to ensure the relationships between the system components and attributes are properly reflected in the graph.

According to one aspect, shown in block 510, the system may determine if an error is detected. If there is no error, the system may continue collecting telemetry data and updating the correlation matrix and graph. If, however, an error is detected, the system may access, read or otherwise process the error attribute map, shown in block 512, to fetch the error attributes (e.g., a first set of attributes) associated with the detected error code. With the knowledge of the first set of attributes, the system may fetch or otherwise determine from the correlation graph one or more correlated error attributes (e.g., a second set of attributes), shown in block 514. The correlated error attributes may be attributes not listed in the error attribute map but connected to the first set of attributes by one or more edges in the correlation graph.

The system may, as shown in block 516, fetch the data values corresponding to the first and second sets of error attributes from the datastore. The data values may represent a snapshot or moment-in-time state of the system when the error occurred. Further, the data values may be expansive enough to capture data previously unknown to be related to the error, while also focusing the data collected to the high-value operational data to effectively and efficiently describe the state of the system at the time of the error. As shown in block 518, the attribute values, along with the error code, may be packaged and sent to a support team or other destination where the data may be analyzed. According to one aspect, the correlation graph may also be included in the package.

FIG. 6 is a diagram of an example of a storage system 600, according to aspects of the disclosure. According to one aspect, the storage system 600 may be or include a complex system to be monitored for high-value error data collection. As illustrated, the system 600 may include a storage array 604, a communications network 606, and a plurality of host devices 630. The communications network 606 may include one or more of a fibre channel (FC) network, the Internet, a local area network (LAN), a wide area network (WAN), and/or any other suitable type of network. The storage array 604 may include a storage system, such as DELL/EMC Powermax™, DELL PowerStore™, and/or any other suitable type of storage system. The storage array 604 may include or be arranged with one or more node-pairs and a plurality of non-volatile memory storage devices 614. Each node of the node pairs may include one or more storage processors 602. Each of the storage processors 602 may be configured to receive Input/Output (I/O) requests from host devices 630 and execute the received I/O requests by reading and/or writing data to storage devices 614. Each of the host devices 630 may include a desktop computer, a laptop, a smartphone, an internet-of-things (IoT) device, and/or any other suitable type of computing device.

According to one aspect, each of storage devices 614 may be a non-volatile memory express (NVMe) drive. In another aspect, the storage devices may be solid-state drives (SSD). In some implementations, each of the storage devices 614 may be connected to the storage processors 602 via a Peripheral Component Interconnect Express (PCIe) connection. Each of the storage devices 614 may include a respective controller (not shown) and storage medium (not shown). The controller of each storage device 614 may include processing circuitry that is configured to perform various tasks, such as the retrieval and storage of data on the medium, wear leveling, error handling, garbage collection, as well as other functions. The medium may include an array of NAND memory cells and/or any other suitable type of storage medium.

In some implementations, any of the storage devices 614 may be internal to one of the storage processors 602 and coupled to the storage processor via an M.2 slot that is provided on the motherboard of that storage processor. Additionally, or alternatively, in some implementations, any of the storage devices 614 may be part of a disk array enclosure (DAE) and coupled to each of the storage processors 602 via a respective InfiniBand adapter of that storage processor. It will be understood that the present disclosure is not limited to any specific

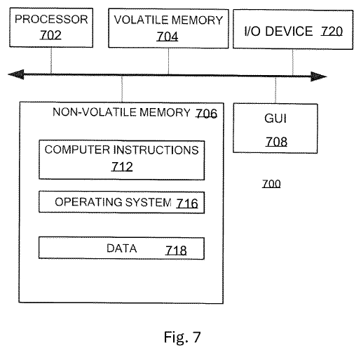

Referring to FIG. 7, in some embodiments, a computing device 700 may include processor 702, volatile memory 704 (e.g., RAM), non-volatile memory 706 (e.g., a hard disk drive, a solid-state drive such as a flash drive, a hybrid magnetic and solid-state drive, etc.), graphical user interface (GUI) 708 (e.g., a touchscreen, a display, and so forth) and input/output (I/O) device 720 (e.g., a mouse, a keyboard, etc.). Non-volatile memory 706 stores computer instructions 712, an operating system 716 and data 718 such that, for example, the computer instructions 712 are executed by the processor 702 out of volatile memory 704. Program code may be applied to data entered using an input device of GUI 708 or received from I/O device 720.

FIGS. 1-7 are provided as an example only. In some aspects or embodiments, the term “I/O request” or simply “I/O” may be used to refer to an input or output request. In some embodiments, an I/O request may refer to a data read or write request. At least some of the steps discussed with respect to FIGS. 1-7 may be performed in parallel, in a different order, or altogether omitted. As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

To the extent directional terms are used in the specification and claims (e.g., upper, lower, parallel, perpendicular, etc.), these terms are merely intended to assist in describing and claiming the invention and are not intended to limit the claims in any way. Such terms do not require exactness (e.g., exact perpendicularity or exact parallelism, etc.), but instead it is intended that normal tolerances and ranges apply. Similarly, unless explicitly stated otherwise, each numerical value and range should be interpreted as being approximate as if the word “about”, “substantially” or “approximately” preceded the value of the value or range.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

While the exemplary embodiments have been described with respect to processes of circuits, including possible implementation as a single integrated circuit, a multi-chip module, a single card, or a multi-card circuit pack, the described embodiments are not so limited. As would be apparent to one skilled in the art, various functions of circuit elements may also be implemented as processing blocks in a software program. Such software may be employed in, for example, a digital signal processor, micro-controller, or general-purpose computer.

Some embodiments might be implemented in the form of methods and apparatuses for practicing those methods. Described embodiments might also be implemented in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the claimed invention. Described embodiments might also be implemented in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the claimed invention. When implemented on a general-purpose processor, the program code segments combine with the processor to provide a unique device that operates analogously to specific logic circuits. Described embodiments might also be implemented in the form of a bitstream or other sequence of signal values electrically or optically transmitted through a medium, stored magnetic-field variations in a magnetic recording medium, etc., generated using a method and/or an apparatus of the claimed invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,”etc., imply the absence of such additional elements.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

It will be further understood that various changes in the details, materials, and arrangements of the parts which have been described and illustrated in order to explain the nature of the claimed invention might be made by those skilled in the art without departing from the scope of the following claims.

What is claimed is:

1. A computer-implemented method comprising:
providing an error map associating one or more system attributes to an error code;
detecting a system error;
identifying, in the error map, one or more first system attributes associated with the error code;
identifying one or more second system attributes associated with the one or more first system attributes, wherein the one or more second system attributes are correlated with the one or more first system attributes according to a correlation graph;
collecting telemetry data related to the one or more first and second system attributes; and
generating a data package including the error code and the telemetry data related to the one or more first and second system attributes.

2. The method of claim 1 further comprising generating a correlation matrix of the one or more system attributes, the correlation graph generated from the correlation matrix.

3. The method of claim 1 wherein the correlation graph includes a plurality of nodes corresponding to the one or more first and second system attributes and a plurality of edges corresponding to a correlation between at least two nodes of the plurality of nodes.

4. The method of claim 3 wherein a length of an edge in the correlation graph is indicative of a correlation strength between two error attributes represented by the two nodes.

5. The method of claim 4 wherein the correlation strength increases as the length of the edge decreases.

6. The method of claim 1 wherein the telemetry data includes a point-in-time snapshot of a plurality of values associated with the one or more first and second system attributes.

7. The method of claim 1 wherein the correlation graph is generated from telemetry data.

8. The method of claim 1 wherein the correlation graph is periodically generated using updated telemetry data.

9. A system comprising:
a memory; and
at least one processor that is operatively coupled to the memory, the at least one processor being configured to perform the operations of:
providing an error map associating one or more system attributes to an error code;
detecting a system error;
identifying, in the error map, one or more first system attributes associated with the error code;
identifying one or more second system attributes associated with the one or more first system attributes, wherein the one or more second system attributes are correlated with the one or more first system attributes according to a correlation graph;
collecting telemetry data related to the one or more first and second system attributes; and
generating a data package including the error code and the telemetry data related to the one or more first and second system attributes.

10. The system of claim 9 further comprising generating a correlation matrix of the one or more system attributes, the correlation graph generated from the correlation matrix.

11. The system of claim 9 wherein the correlation graph includes a plurality of nodes corresponding to the one or more first and second system attributes and a plurality of edges corresponding to a correlation between at least two nodes of the plurality of nodes.

12. The system of claim 11 wherein a length of an edge in the correlation graph is indicative of a correlation strength between two error attributes represented by the two nodes.

13. The system of claim 12 wherein the correlation strength increases as the length of the edge decreases.

14. The system of claim 9 wherein the telemetry data includes a point-in-time snapshot of a plurality of values associated with the one or more first and second system attributes.

15. The system of claim 9 wherein the correlation graph is generated from telemetry data.

16. The system of claim 9 wherein the correlation graph is periodically generated using updated telemetry data.

17. A non-transitory computer-readable medium storing one or more processor-executable instructions, which when executed by at least one processor cause the at least one processor to perform the operations of:
providing an error map associating one or more system attributes to an error code;
detecting a system error;
identifying, in the error map, one or more first system attributes associated with the error code;
identifying one or more second system attributes associated with the one or more first system attributes, wherein the one or more second system attributes are correlated with the one or more first system attributes according to a correlation graph;
collecting telemetry data related to the one or more first and second system attributes; and
generating a data package including the error code and the telemetry data related to the one or more first and second system attributes.

18. The non-transitory computer-readable medium of claim 17 further comprising instructions to perform the operations of generating a correlation matrix of the one or more system attributes, the correlation graph generated from the correlation matrix.

19. The non-transitory computer-readable medium of claim 17 wherein the correlation graph includes a plurality of nodes corresponding to the one or more first and second system attributes and a plurality of edges corresponding to a correlation between at least two nodes of the plurality of nodes.

20. The non-transitory computer-readable medium of claim 19 wherein a length of an edge in the correlation graph is indicative of a correlation strength between two error attributes represented by the two nodes, the correlation strength increases as the length of the edge decreases.
